(19) United States
(12) Patent Application Publication
(10) Pub. No.: US 2024/0041000 A1
(43) Pub. Date: Feb. 8, 2024

(54) DROOL-RESISTANT DOG TOY

(71) Applicant: CAITLIN TESSLER, Ottawa (CA)

(72) Inventor: CAITLIN TESSLER, Ottawa (CA)

(21) Appl. No.: 17/879,984

(22) Filed: Aug. 3, 2022

(51) Int. Cl. A01K 15/02; B32B 1/00

(52) U.S. Cl. CPC A01K 15/025; B32B 1/00; B32B 27/36

(57) ABSTRACT

The drool-resistant dog toy is a toy. The drool-resistant dog toy comprises a core structure, a hydrophobic structure, and a companion animal. The core structure and the hydrophobic structure combine to form a toy that entertains and distracts the companion animal. The combination of the core structure and the hydrophobic structure forms a composite structure. The core structure forms the primary shape of the drool-resistant dog toy. The hydrophobic structure forms an enclosure that encloses the core structure. The hydrophobic structure repels bodily fluids released by the companion animal.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of toys specially adapted for animals. (A01K15/025)

### SUMMARY OF INVENTION

The drool-resistant dog toy is a toy. The drool-resistant dog toy comprises a core structure, a hydrophobic structure, and a companion animal. The core structure and the hydrophobic structure combine to form a toy that entertains and distracts the companion animal. The combination of the core structure and the hydrophobic structure forms a composite structure. The core structure forms the primary shape of the drool-resistant dog toy. The hydrophobic structure forms an enclosure that encloses the core structure. The hydrophobic structure repels bodily fluids released by the companion animal.

These together with additional objects, features and advantages of the drool-resistant dog toy will be readily apparent to those of ordinary skill in the art upon reading the following detailed description of the presently preferred, but nonetheless illustrative, embodiments when taken in conjunction with the accompanying drawings.

In this respect, before explaining the current embodiments of the drool-resistant dog toy in detail, it is to be understood that the drool-resistant dog toy is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the drool-resistant dog toy.

It is therefore important that the claims be regarded as including such equivalent construction insofar as they do not depart from the spirit and scope of the drool-resistant dog toy. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a cross-sectional view of an embodiment of the disclosure across 2-2 as shown in FIG. 1.

FIG. 3 is a perspective view of an alternate embodiment of the disclosure.

FIG. 4 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

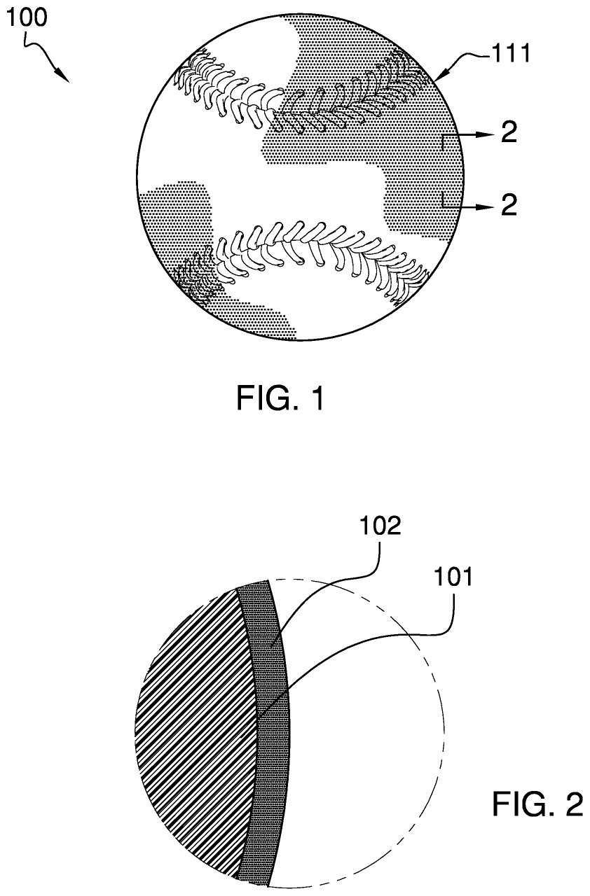

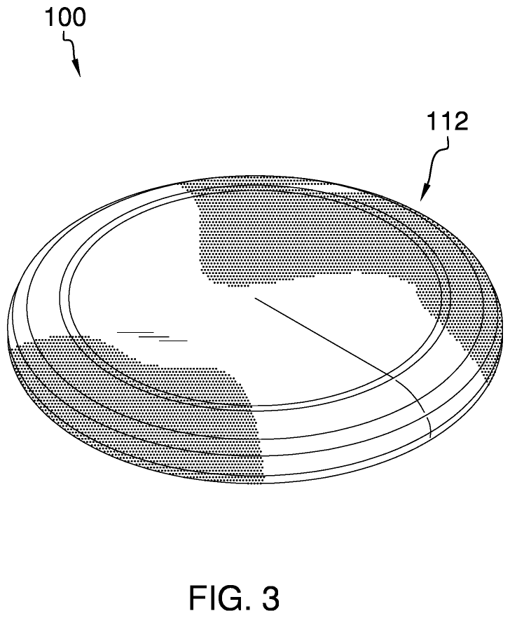

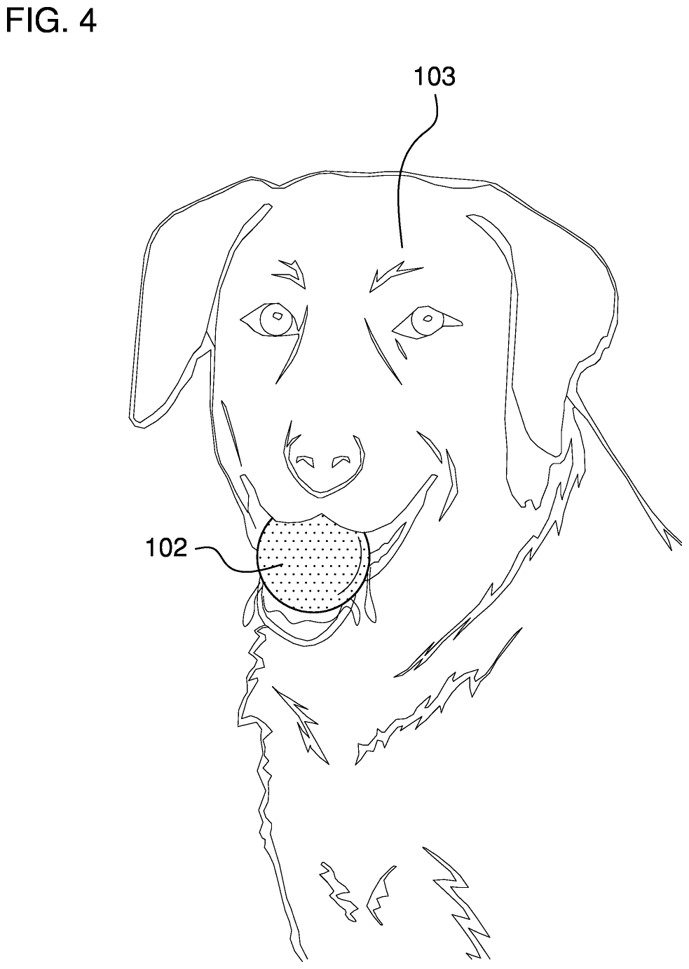

Detailed reference will now be made to one or more potential embodiments of the disclosure, which are illustrated in FIGS. 1 through 4.

The drool-resistant dog toy 100 (hereinafter invention) is a toy. The invention 100 comprises a core structure 101, a hydrophobic structure 102, and a companion animal 103. The core structure 101 and the hydrophobic structure 102 combine to form a toy that entertains and distracts the companion animal 103. The combination of the core structure 101 and the hydrophobic structure 102 forms a composite structure. The core structure 101 forms the primary shape of the invention 100. The hydrophobic structure 102 forms an enclosure that encloses the core structure 101. The hydrophobic structure 102 repels bodily fluids released by the companion animal 103. The companion animal 103 is defined elsewhere in this disclosure.

The core structure 101 is a mechanical structure. The core structure 101 is a solid structure. The core structure 101 is formed in a form factor. The form factor of the core structure 101 is a geometric structure. The core structure 101 has a semi-rigid structure. The core structure 101 forms the structure of the invention 100 that entertains and diverts the companion animal 103.

The form factor of the core structure 101 is selected from the group consisting of ball structure 111 and a disk structure 112.

The ball structure 111 is a spherical structure. The ball structure 111 forms a structure that can be caught from the air by the companion animal 103.

The disk structure 112 is a roughly pan shaped structure. The disk structure 112 is an aerodynamically shaped structure. By aerodynamically shaped is meant that the flight path of the disk structure 112 can be controlled when the disk structure 112 is thrown towards a target. The disk structure 112 forms a structure that can be caught from the air by the companion animal 103.

The hydrophobic structure 102 is a mechanical structure. The hydrophobic structure 102 forms an enclosure that encloses the core structure 101. The hydrophobic structure 102 encloses the exterior surfaces of the core structure 101.

The hydrophobic structure 102 is formed from a hydrophobic material. Material suitable for use as the hydrophobic structure 102 include but are not limited to: a) nylon (CAS: Type 6: 25038-54-5; Type 6,6: 32131-17-2); b) poly(ethylene terephthalate) (CAS 25038-59-9); and, c) polypropylene (CAS 9003-07-0).

The hydrophobic structure 102 forms a protective barrier that prevents bodily fluids from flowing into the core structure 101. The hydrophobic structure 102 has a semi-rigid structure. The hydrophobic structure 102 encloses the exterior surfaces of the core structure 101 as an even layer. The hydrophobic structure 102 repels the bodily fluids that are generated by the companion animal 103.

The following definitions were used in this disclosure:
Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.
Ball: As used in this disclosure, a ball refers to an object with a spherical or nearly spherical shape.
Cant: As used in this disclosure, a cant is an angular deviation from one or more reference lines (or planes) such as a vertical line (or plane) or a horizontal line (or plane).
Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.
Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.
Coating: As used in this disclosure, a coating refers to a substance that is applied to the exterior surface of an object such that the coating forms a new exterior surface of the object. A coating is commonly said to be formed as a layer. Paint is an example of a common coating material.
Companion Animal: As used in this disclosure, a companion animal is a domesticated animal that is maintained primarily for companionship. A companion animal is often referred to as a pet.
Composite: As used in this disclosure, composite refers to a two-dimensional or three-dimensional structure that is formed from two or more distinctly identifiable layered sub-structures.
Composite Prism: As used in this disclosure, a composite prism refers to a structure that is formed from a plurality of structures selected from the group consisting of a prism structure and a pyramid structure. The plurality of selected structures may or may not be truncated. The plurality of prism structures are joined together such that the center axes of each of the plurality of structures are aligned. The congruent ends of any two structures selected from the group consisting of a prism structure and a pyramid structure need not be geometrically similar.
Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.
Correspond: As used in this disclosure, the term correspond is used as a comparison between two or more objects wherein one or more properties shared by the two or more objects match, agree, or align within acceptable manufacturing tolerances.
Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.
Enclose: As used in this disclosure, to enclose means to segregate or surround a space or an object from all sides. The noun form of enclose is enclosure.
Exterior: As used in this disclosure, the exterior is used as a relational term that implies that an object is not contained within the boundary of a structure or a space.
Form Factor: As used in this disclosure, the term form factor refers to the size and shape of an object.
Fiber: As used in this disclosure, a fiber is a slender elongated structure. A synthetic fiber refers to a fiber that is formed from a synthesized polymer. Common polymers used to from synthetic fibers include, but are not limited to, nylon (CAS: Type 6: 25038-54-5; Type 6,6: 32131-17-2), poly(ethylene terephthalate) (CAS 25038-59-9), and polypropylene (CAS 9003-07-0).
Filament: As used in this disclosure, a filament is a thread like fiber or object that is used in the production of a yarn. A synthetic filament refers to a filament formed from synthetic fibers.
Flexible: As used in this disclosure, flexible refers to an object or material that will deform when a force is applied to it but that will not necessarily return to its original shape when the deforming force is removed.
Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.
Hydrophobic: As used in this disclosure, hydrophobic refers to a substance that repels and does not mix with water. Hydrophobic materials are often selected because they will not absorb water.
Include, But Are Not Limited To: As used in this disclosure, the term “include, but are not limited to” is a phrase used to introduce representative examples of structures that meet the requirements of the first phrase. As a first example of the use of the term “include, but are not limited to,” the phrase: “the first textile attaches to the second textile using a fastener such as a hook and loop fastener” is taken to mean that a hook and loop fastener is suitable to use as the fastener but is not meant to exclude the use of a zipper or a sewn seam. As a second example of the use of the term “include, but are not limited to,” the phrase: “the chemical substance is a halogen such as chlorine or bromine” is taken to mean that either chlorine or bromine are suitable for use as the halogen but is not meant to exclude the use of fluorine or iodine.
Interior: As used in this disclosure, the interior is used as a relational term that implies that an object is contained within the boundary of a structure or a space.
Negative Space: As used in this disclosure, negative space is a method of defining an object through the use of open or empty space as the definition of the object itself, or, through the use of open or empty space to describe the boundaries of an object.
One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.
Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan are open.
Perimeter: As used in this disclosure, a perimeter is one or more curved or straight lines that bounds an enclosed area on a plane or surface. The perimeter of a circle is commonly referred to as a circumference.
Primary Shape: As used in this disclosure, the primary shape refers to a description of the rough overall geometric shape of an object that is assembled from multiple components or surfaces.
Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.
Not Significantly Different: As used in this disclosure, the term not significantly different compares a specified property of a first object to the corresponding property of a reference object (reference property). The specified property is considered to be not significantly different from the reference property when the absolute value of the difference between the specified property and the reference property is less than 10.0% of the reference property value. A negligible difference is considered to be not significantly different.
Roughly: As used in this disclosure, roughly refers to a comparison between two objects. Roughly means that the difference between one or more parameters of the two compared objects are not significantly different.
Semi-Rigid Structure: As used in this disclosure, a semi-rigid structure is a solid structure that is stiff but not wholly inflexible and that will deform under force before breaking. A semi-rigid structure may or may not behave with an elastic nature in that a semi-rigid structure need not return to its relaxed shape.
Sphere: As used in this disclosure, a sphere refers to a structure wherein every point of the surface of the structure is equidistant from a center point. A circle refers to the two dimensional structure that that is projected onto the bifurcating plane of a spherical section by the surface of the sphere. All the points of the circle are equidistant from a center point that is found by the perpendicular projection of the center of the sphere on the bifurcating plane.
Such As: As used in this disclosure, the term “such as” is a conjunction that relates a first phrase to a subsequent phrase. The term “such as” is used to introduce representative examples of structures that meet the requirements of the first phrase. As a first example of the use of the term “such as,” the phrase: “the first textile attaches to the second textile using a fastener such as a hook and loop fastener” is taken to mean that a hook and loop fastener is suitable to use as the fastener but is not meant to exclude the use of a zipper or a sewn seam. As a second example of the use of the term “such as,” the phrase: “the chemical substance is a halogen such as chlorine or bromine” is taken to mean that either chlorine or bromine are suitable for use as the halogen but is not meant to exclude the use of fluorine or iodine.
Such That: As used in this disclosure, the term “such that” is a conjunction that relates a first phrase to a subsequent phrase. The term “such that” is used to place a further limitation or requirement to the first phrase. As a first example of the use of the term “such that,” the phrase: “the door attaches to the wall such that the door rotates relative to the wall” requires that the attachment of the door allows for this rotation. As a second example of the use of the term “such that,” the phrase: “the chemical substance is selected such that the chemical substance is soluble in water” requires that the selected chemical substance is soluble in water. As a third example of the use of the term “such that,” the phrase: “the lamp circuit is constructed such that the lamp circuit illuminates when the lamp circuit detects darkness” requires that the lamp circuit: a) detect the darkness; and, b) generate the illumination when the darkness is detected.
Toy: As used in this disclosure, a toy is a physical object used to entertain or distract an individual or an animal.

With respect to the above description, it is to be realized that the optimum dimensional relationship for the various components of the invention described above and in FIGS. 1 through 2 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A drool-resistant dog toy comprising
a core structure, a hydrophobic structure, and a companion animal;
wherein the core structure and the hydrophobic structure combine to form a toy that entertains and distracts the companion animal.

2. The drool-resistant dog toy according to claim 1 wherein the combination of the core structure and the hydrophobic structure forms a composite structure.

3. The drool-resistant dog toy according to claim 2
wherein the core structure forms the primary shape of the drool-resistant dog toy;
wherein the hydrophobic structure forms an enclosure that encloses the core structure;
wherein the hydrophobic structure repels bodily fluids released by the companion animal.

4. The drool-resistant dog toy according to claim 3
wherein the core structure is a mechanical structure;
wherein the core structure is a solid structure.

5. The drool-resistant dog toy according to claim 4
wherein the core structure is formed in a form factor;
wherein the form factor of the core structure is a geometric structure.

6. The drool-resistant dog toy according to claim 5
wherein the core structure has a semi-rigid structure;
wherein the core structure forms the structure of the drool-resistant dog toy that entertains and diverts the companion animal.

7. The drool-resistant dog toy according to claim 6
wherein the hydrophobic structure is a mechanical structure;
wherein the hydrophobic structure forms an enclosure that encloses the core structure.

8. The drool-resistant dog toy according to claim 5
wherein the hydrophobic structure encloses the exterior surfaces of the core structure;
wherein the hydrophobic structure is formed from a hydrophobic material.

9. The drool-resistant dog toy according to claim 8
wherein the hydrophobic structure forms a protective barrier that prevents bodily fluids from flowing into the core structure;
wherein the hydrophobic structure has a semi-rigid structure;
wherein the hydrophobic structure encloses the exterior surfaces of the core structure as an even layer;
wherein the hydrophobic structure repels the bodily fluids that are generated by the companion animal.

10. The drool-resistant dog toy according to claim 9
wherein the form factor of the core structure is selected from the group consisting of ball structure and a disk structure;
wherein the ball structure is a spherical structure;
wherein the ball structure forms a structure that can be caught from the air by the companion animal;
wherein the disk structure is a roughly pan shaped structure;
wherein the disk structure is an aerodynamically shaped structure;
wherein by aerodynamically shaped is meant that the flight path of the disk structure can be controlled when the disk structure is thrown towards a target;
wherein the disk structure forms a structure that can be caught from the air by the companion animal;

11. The drool-resistant dog toy according to claim 10
wherein the form factor of the core structure is selected from the group consisting of ball structure and a disk structure;
wherein the ball structure is a spherical structure;
wherein the ball structure forms a structure that can be caught from the air by the companion animal;
wherein the disk structure is a roughly pan shaped structure;
wherein the disk structure is an aerodynamically shaped structure;
wherein by aerodynamically shaped is meant that the flight path of the disk structure can be controlled when the disk structure is thrown towards a target;
wherein the disk structure forms a structure that can be caught from the air by the companion animal.

12. The drool-resistant dog toy according to claim 10
wherein the form factor of the core structure has a ball structure;
wherein the ball structure is a spherical structure;
wherein the ball structure forms a structure that can be caught from the air by the companion animal.

13. The drool-resistant dog toy according to claim 10
wherein the form factor of the core structure has a disk structure;
wherein the disk structure is a roughly pan shaped structure;
wherein the disk structure is an aerodynamically shaped structure;
wherein by aerodynamically shaped is meant that the flight path of the disk structure can be controlled when the disk structure is thrown towards a target;
wherein the disk structure forms a structure that can be caught from the air by the companion animal.
